(19) United States
(12) Patent Application Publication
(10) Pub. No.: US 2026/0170590 A1
(43) Pub. Date: Jun. 18, 2026

(54) GRAPHICS PROCESSING

(71) Applicant: Arm Limited, Cambridge (GB)

(72) Inventors: Philip Carlos Garcia, Austin, TX (US); Harsh Ashok Gugale, Austin, TX (US); Frank Klaeboe Langtind, Melhus (NO)

(73) Assignee: Arm Limited, Cambridge (GB)

(21) Appl. No.: 18/982,190

(22) Filed: Dec. 16, 2024

(51) Int. Cl. G06T 1/20; G06T 1/60; G06T 17/20

(52) U.S. Cl. CPC G06T 1/20; G06T 1/60; G06T 17/20

(57) ABSTRACT

In a graphics processor that is configured to execute a tile-based graphics processing pipeline a geometry buffer is provided that is operable to store ‘temporary’ geometry items that are produced by and then consumed during the initial, geometry processing pass of the tile-based graphics processing pipeline. Access logic is operable and configured to control a maximum amount of storage space within the geometry buffer that is available to be allocated for storing new such temporary geometry items produced by the sequence of one or more geometry processing stages.

### BACKGROUND

The technology described herein relates to graphics processing, and in particular to tile-based graphics processing.

Graphics processing is normally carried out by first splitting a scene (e.g. a 3D model) to be rendered (e.g. for display) into a number of similar basic components or “primitives”, which primitives are then subjected to the desired graphics processing operations. The graphics primitives are usually in the form of simple polygons such as triangles, quadrilaterals, points, lines or groups thereof.

Each primitive is usually defined by and represented as a set of vertices (e.g. three vertices in the case of a triangular primitive). The vertices that are to be used for the primitives will have respective sets of vertex data defining the vertices, e.g. the relevant attributes for each of the vertices. These attributes will typically include position data and other, non-position data (varyings), e.g. defining colour, light, normal, texture coordinates, etc., for the vertex in question.

In tile-based graphics processing, the two-dimensional graphics processing (render) output (i.e. the output of the rendering process, such as an output frame to be displayed) is generated (rendered) as a plurality of smaller area regions, usually referred to as “tiles”. The render output is typically divided (by area) into regularly-sized and shaped rendering tiles (they are usually e.g. squares or rectangles). The tiles are each rendered separately (e.g. one after another). The rendered tiles are then combined to provide the complete render output (e.g. frame for display).

When performing tile-based graphics processing, there will normally be some initial geometry processing, such as vertex processing (vertex shading) of attributes for vertices to be used for primitives for the render output being generated, to generate geometry (and other) data required for rendering the graphics processing output.

The geometry processing will then be followed by a tiling/binning process that generates appropriate data structures for determining which geometry (e.g. primitives) needs to be processed for respective rendering tiles of the output being generated. For instance, in tile-based graphics processing, it is usually desirable to be able to (try to) identify the geometry (e.g. primitives) for the render output that need to be processed for a given rendering tile, so as to avoid unnecessarily processing geometry that does not actually apply to a rendering tile. To facilitate this, a tiling/binning process is performed that effectively sorts the geometry relative to the rendering tiles.

Once the binning/tiling process has generated the necessary data structures for identifying geometry to be processed for respective tiles of the render output, the geometry can then be, and will be, subjected to appropriate rendering/fragment processing. This may comprise, for example, rasterising primitives to be processed to fragments, fragment shading of the fragments, and/or performing ray tracing operations. The rendering/fragment processing operation is performed on a tile-by-tile basis, using the data structures generated by the tiling/binning process to identify the geometry (e.g. primitives) that need to be processed for a respective rendering tile.

The rendered tiles may then be combined appropriately to provide the overall render output (e.g. frame for display).

The inventors believe that there remains scope for improvements to the operation of tile-based graphics processors.

### BRIEF DESCRIPTION OF THE DRAWINGS

Embodiments of the technology described herein will now be described by way of example only and with reference to the accompanying drawings, in which:

FIG. 1 shows an exemplary data processing system in which the technology described herein may be implemented;

FIG. 2 shows an exemplary graphics processing pipeline;

FIG. 3 shows schematically a graphics processor that may be operated in accordance with the technology described herein;

FIG. 4A and FIG. 4B illustrate a dynamic re-sizing of a geometry buffer according to an embodiment;

FIG. 5 is a flow chart illustrating a memory management operation according to an embodiment; and

FIG. 6 illustrates another example of dynamic re-sizing of a geometry buffer according to an embodiment.

Like reference numerals are used for like features in the Figures, where appropriate.

### DETAILED DESCRIPTION

A first embodiment of the technology described herein comprises a data processing system comprising a graphics processor that is configured to execute a tile-based graphics processing pipeline in which a render output is generated by performing an initial, “geometry processing” pass and a subsequent, “rendering” pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage to render respective (render output) tiles,
the data processing system further comprising:
a geometry buffer for storing (temporary) geometry items that are produced by the sequence of one or more geometry processing stages and then consumed during the initial, geometry processing pass; and
the graphics processor further comprising access logic for controlling access to the geometry buffer,
wherein the access logic is operable and configured to control a maximum amount of storage space within the geometry buffer that is available to be allocated for storing new geometry items produced by the sequence of one or more geometry processing stages.

A second embodiment of the technology described herein comprises a method of operating a data processing system comprising a graphics processor that is configured to execute a tile-based graphics processing pipeline in which a render output is generated by performing an initial, “geometry processing” pass and a subsequent, “rendering” pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage to render respective (render output) tiles,
the data processing system further comprising:
a geometry buffer for storing (temporary) geometry items that are produced by the sequence of one or more geometry processing stages and then consumed during the initial, geometry processing pass; and
the method comprising:
controlling a maximum amount of storage space within the geometry buffer that is available to be allocated for storing new geometry items produced by the sequence of one or more geometry processing stages, based on current processing conditions within the graphics processor.

The technology described herein relates generally to graphics processors that are operable and configured to perform so-called “tile-based” rendering in which a render output (e.g. frame) to be generated is subdivided for the purposes of rendering into a plurality of smaller-area rendering “tiles”. Each rendering tile can then be, and typically is, rendered separately.

To facilitate this, in tile-based rendering, a render pass is effectively split into two separate processing passes, namely an initial, “geometry processing” pass that executes the geometry related processing including the geometry binning, and generates appropriate data structures for determining which geometry needs to be processed for respective rendering tiles of the output being generated, and a subsequent, (deferred) “rendering” pass that renders respective rendering tiles of the render output.

The deferred rendering pass executes the rendering/fragment processing on a tile-by-tile basis and writes the rendered tiles back to memory once the rendering/fragment processing has been completed.

The graphics processor will thus include suitable processing circuits for implementing the various (different) stages of the tile-based graphics processing pipeline that is to be executed, which stages will include a set of one or more geometry processing stages (to perform geometry processing), a binning stage (to generate the data structures for determining which geometry needs to be processed for respective rendering tiles of the output being generated, the geometry processing stages and the binning stage thus together constituting the initial, “geometry processing” pass), and a rendering stage (to render the respective tiles during the subsequent, “rendering” pass).

These stages are further arranged in a “pipelined” manner that defines the particular sequence of processing operations to be performed when generating a render output, and hence the corresponding data ‘flow’.

For instance, in embodiments, as will be described below, the geometry processing stages of the graphics processing pipeline that is executed by the graphics processor perform processing for “packets” of geometry, e.g., and in embodiments, such that the geometry processing stages (prior to the binning stage) operates to produce respective “packets” of (processed) geometry, each packet storing data for geometry to be further processed by the graphics processor.

The end result of the geometry processing performed by the sequence of geometry processing stages may thus be, and in embodiments is, to produce respective geometry packets for storing appropriate geometry data, such as (transformed) vertex positions, vertex varyings, and primitive attributes, which geometry data will then be used, for example, by the rendering/fragment processing of the later stages of the tile-based graphics processing pipeline.

The geometry data that has been completely processed by the set of one or more geometry processing stages and that may be used by the rendering/fragment processing stage may be referred to as “intermediate” geometry data. This intermediate geometry data may thus be written out, e.g., by the final geometry stage in the set of one or more geometry processing stages, and/or by the binning stage, to appropriate storage, e.g. in (main) memory, so that this intermediate geometry data can then be used, as needed, for the rendering/fragment processing of the later stages of the tile-based graphics processing pipeline.

In this respect, it will be appreciated that a large number of intermediate geometry items may be produced, and this intermediate geometry data may need to be stored for the entire duration of a render pass (i.e. until the current render pass has completed), so appropriate (e.g. external) storage needs to be provided to be able to handle this.

In the tile-based graphics processing pipeline that is executed by the graphics processor according to the technology described herein, there will also be various “temporary” geometry data that is produced by the geometry processing stages, but that will also be consumed during the initial, geometry processing pass. This “temporary” geometry data will correspondingly therefore have a much shorter lifetime than the so-called “intermediate” geometry data discussed above that is the end result of the initial, geometry processing pass.

For instance, a given input packet that is provided to a particular geometry processing stage within the geometry processing stages of the graphics processing pipeline may be further processed within that geometry processing stage to generate zero or more output packets, which output packets may in turn be passed to a next geometry processing stage for processing.

So, for example, a vertex shading stage will in embodiments receive an input set of vertices that have been defined for a render output and process these to produce a processed vertex packet containing corresponding processed (shaded) vertex data, etc. The vertex packet may then be provided to a next geometry processing stage for further processing (which next geometry processing stage may, e.g., be a tessellation or geometry shader stage, depending on the particular sequence of geometry processing operations that is to be performed), and so on.

Various arrangements are possible in this regard, e.g. depending on the particular geometry processing pipeline that is to be supported, and in general the geometry items that are processed/produced by the geometry processing stages may take any suitable and desired form.

Correspondingly, as will be explained further below, the binning stage in embodiments then processes the geometry items (e.g. packets) produced by the geometry processing stages, or at least processes data structures (e.g. bounding boxes) associated with or derived from these geometry items, to thereby generate the appropriate data structures for identifying which primitives are to be processed when rendering which respective tiles of the render output being generated.

Thus, in the tile-based graphics processing pipeline that is executed by the graphics processor according to the technology described herein, the initial, geometry processing pass that is performed for a particular render output will produce various “temporary” geometry items, i.e. geometry items that are produced by the geometry processing stages during the processing of data for a particular render output, but which geometry items will be subsequently consumed during the same initial, geometry processing pass. These temporary geometry items may, for example, include geometry items that are produced by one geometry processing stage that are then consumed by another, later geometry processing stage, and/or geometry items that are consumed by the binning stage.

These “temporary” geometry items may therefore need to be temporarily stored, as they should remain available to the graphics processor until any and all further processing that uses them has completed.

These “temporary” geometry items, however, they do not constitute part of the final (rendered) output data generated by the graphics processor and are instead consumed during the initial, geometry processing pass.

Accordingly, these temporary geometry items can be discarded once the processing during the initial, geometry processing pass that uses these temporary geometry items has completed (and so this is different to the “intermediate” geometry data that is written out at the end of the initial, geometry processing pass and that may be used during the subsequent, rendering pass and so may need to be stored for the entire duration of the render pass).

The graphics processor of the technology described herein thus also has access to suitable storage in the form of a “geometry buffer” that is operable to store such (temporary) geometry items that are produced by the sequence of one or more geometry processing stages and that will also be consumed during the initial, geometry processing pass.

In embodiments, this storage is dedicated for storing such (temporary) geometry items that are produced by the sequence of one or more geometry processing stages and that will also be consumed during the initial, geometry processing pass (and so it is different and separate to any storage that is used for storing the “intermediate” geometry data that needs to be stored for the duration of the render pass, for instance).

This storage, i.e. the geometry buffer, may take any suitable and desired form but in embodiments, and typically, is held locally to, and “on chip” with, the graphics processor. For instance, in embodiments, the graphics processor accesses the geometry buffer via a cache system that is operable to transfer data between the graphics processor and a memory system (e.g. main memory) and the geometry buffer in embodiments resides within this cache system.

This then means that at least some of the (temporary) geometry items (packets) that are produced by the geometry processing stages and that will also be consumed during the initial, geometry processing pass can be, and in embodiments are, held more locally to the graphics processor.

For example, in embodiments, the graphics processor comprises a cache, e.g., and in embodiments, in the form of a (shared) level 2 (L2) cache, that is provided locally to, and “on chip” with, the graphics processor (although it will be appreciated that multiple levels of caching may be provided, as desired), and the geometry buffer in embodiments resides within this level 2 (L2) cache.

Providing such local cache storage can then facilitate storing some (and in embodiments all) of the (temporary) geometry items (packets) locally, e.g. “on chip” with the graphics processor, thus in embodiments saving having to write the (temporary) geometry items (packets) out to an external memory system.

(It will be appreciated that the cache system will generally be backed by a memory system and so the geometry buffer could in some instances be written out to memory, e.g. in the event of a cache overspill. The technology described herein, however, in embodiments avoids this, so that the geometry buffer that stores the (temporary) geometry items (packets) is held entirely within the cache system. For example, and in embodiments, the total (maximum) size of the geometry buffer is configured (and controlled) such that it fully resides within a particular cache (or cache level), e.g. to reduce, and in embodiments avoid, the geometry buffer spilling out to memory.)

According to the technology described herein, this storage (the geometry buffer) is in embodiments configured as a set of one or more memory pools that are operable to store (temporary) geometry items that are produced by the sequence of one or more geometry processing stages and that will also be consumed during the initial, geometry processing pass.

Thus, the set of one or more memory pools can be, and in embodiments are, allocated appropriately to the sequence of one or more geometry processing stages for storing corresponding (temporary) geometry items that are produced by the sequence of one or more geometry processing stages and that will also be consumed during the initial, geometry processing pass.

A memory pool that has been allocated to one or more of the geometry processing stages within the sequence of geometry processing stages is thus generally operable to store the (temporary) geometry items that are to be produced and/or processed by those geometry processing stages.

For example, where the geometry processing stages are operable and configured to process/produce “packets” of geometry, as described above, a memory pool allocated to the sequence of geometry processing stages will be effectively divided into such packets. Thus, a memory pool that has been allocated to a vertex shading stage may be, and in embodiments is, operable to store shaded vertex packets produced by that stage. The vertex shading stage when a new packet is to be produced may thus allocate a respective portion of the memory pool allocated to the vertex shading stage for storing the shaded vertex data for that packet. A later processing stage may then access that packet and generate one or more further packets, for which appropriate space may be allocated in a respective memory pool allocated for the later processing stage, etc. At some point, once the packet has been consumed, e.g. by the last geometry processing stage, the allocated space for that packet can be deallocated, such that the space is made available for storing new packets.

In this respect, it will be appreciated that the sequence of one or more geometry processing stages may generally include any suitable and desired sequence and number of geometry processing stages, and correspondingly the set of one or more memory pools that are allocated to the sequence of one or more geometry processing stages may comprise any suitable number of memory pools.

Various arrangements would be possible in this regard.

For example, in some embodiments, a single, shared memory pool may be allocated for the sequence of geometry processing stages as a whole.

Alternatively, and in other embodiments, a plurality of memory pools may be allocated for the sequence of geometry processing stages, with different memory pools being accessible by different geometry processing stages within the sequence of geometry processing stages. In this case, the geometry buffer may be divided into memory pools that have the same maximum physical size but other arrangements would in general be possible.

The particular control of the technology described herein, as described further below, may thus generally be applied to any suitable one or more memory pools within the geometry buffer, and/or to the geometry buffer as a whole, as desired.

It will be appreciated that the allocation of memory pools to the geometry processing stages is in embodiments performed in advance, e.g. in software, when configuring the graphics processing pipeline. The initial configuration in embodiments also determines the maximum size of the memory pools within the set of one or more memory pools, etc. within the geometry buffer.

The graphics processor may thus include a memory manager (unit) containing appropriate access logic for controlling the graphics processor's access to the geometry buffer according to this configuration information.

A suitable set of one or more memory pools can thus be configured for a particular graphics processing pipeline, e.g. as part of an initial configuration process. Once a set of memory pools has been suitably configured for a particular graphics processing pipeline, each of the memory pools in the set of memory pools would typically then have a fixed physical size within the geometry buffer (and in embodiments this is also the case in the technology described herein). Thus, the memory pools, once allocated, in embodiments have a fixed physical size within the geometry buffer, e.g. until/unless the graphics processing pipeline is reconfigured.

According to the technology described herein, however, the access logic within the graphics processor that controls access to the geometry buffer is operable and configured to control a maximum amount of storage space within the geometry buffer that is available to be allocated for storing new geometry items produced by the sequence of one or more geometry processing stages.

This is in contrast, therefore, to other systems that may be contemplated where there would be an essentially fixed maximum amount of storage space available for storing (temporary) geometry items produced by the geometry processing stages, e.g. based on the configured size(s) of the memory pool(s) within the geometry buffer.

Thus, the technology described herein allows the maximum amount of storage space that is available for storing (temporary) geometry items produced by the geometry processing stages to be controlled, i.e. such that the maximum amount of storage space that is available can be (and in embodiments is) varied in use, e.g., and in embodiments, based on current processing conditions within the graphics processor.

In this respect, it will be appreciated that the “maximum” amount of storage space that is available corresponds to the effective ‘size’ of the (memory pool(s) within the) geometry buffer, i.e. the amount of storage space that is notionally available to be allocated for new geometry items.

The actual amount of storage currently available at any particularly instant will of course, however, depend on how much of the storage space is already in-use (i.e. is already allocated for storing geometry items). Thus, the actual amount of storage available will generally be determined by the proportion of the maximum amount of storage space that is not currently in-use. When an allocation is to be performed in respect of a new geometry item, therefore, if there is no space currently available, the access logic may need to wait to perform the allocation, e.g. until suitable space has been de-allocated.

Being able to control the maximum amount of storage space that is available for storing (temporary) geometry items in this way may then provide various benefits. For instance, as will be described further below, the inventors have recognised that it may be beneficial to be able to vary the amount of storage that is available for storing (temporary) geometry items produced by the sequence of geometry processing stages in use, based on system conditions. The technology described herein thus permits this to be done, and at least in embodiments further provides a particularly efficient and low complexity mechanism for doing this.

For instance, in embodiments, this control is performed by selectively restricting (or not restricting) an amount of storage space within the geometry buffer that is usable/accessible to be allocated for storing (temporary) geometry items that are produced by the geometry processing stages and that will also be consumed during the initial, geometry processing pass.

For example, as mentioned above, the geometry buffer is in embodiments configured as a set of one or more memory pools that can be allocated to the set of geometry processing stages. A given memory pool may thus have a certain allotted size within the geometry buffer, corresponding to a respective address range for that memory pool.

Thus, in embodiments, the access logic is operable and configured to control the maximum amount of storage space within the geometry buffer that is available to be allocated for storing new geometry items produced by the sequence of one or more geometry processing stages by controlling how much of a memory pool within the geometry buffer that has been allocated to the sequence of one or more geometry processing stages can be allocated for storing new geometry items.

Further, in embodiments, this is done by selectively restricting (or not restricting) the address range that is available to be allocated for storing new geometry items produced by the sequence of one or more geometry processing stages, to thereby control an effective size of the memory pool.

For instance, when a new geometry item is to be stored within the memory pool, the access logic is generally operable to allocate a suitable portion of the allotted address range for the memory pool for storing the new geometry item (i.e. so long as there is space available to be allocated, otherwise the access logic may need to wait until there is space available within the memory pool). In embodiments, the access logic is therefore operable to selectively restrict (or not restrict) how much of the allotted address range for the memory pool is available to be allocated for storing new geometry items and to vary that restriction in use so that the maximum amount of storage space available to be allocated can be changed, as appropriate.

Thus, when it is desired to make a relatively larger amount of storage space available within a particular memory pool within the geometry buffer, the access logic may permit the access logic to allocate space for storing new geometry items within the full allotted address range for that memory pool. On the other hand, when it is desired to make a relatively smaller amount of storage space available within a particular memory pool within the geometry buffer, the access logic may restrict the address range that can be allocated for storing new geometry items. For example, this can be done by adjusting suitable head/tail pointers to change the point where allocations to the memory pool start wrapping.

In this way, the ‘effective’ size of a memory pool that has been allocated to the sequence of one or more geometry processing stages can be (and is) controlled, such that the effective size of the memory pool (and hence the maximum amount of storage available to be allocated for storing (temporary) geometry items produced by the sequence of geometry processing stages) can be varied in use.

That is, in embodiments, the control is achieved by controlling how much of a memory pool that has been allocated to the geometry processing stages is available/accessible to the geometry processing stages (e.g. rather than changing the actual physical size of the memory pool within the geometry buffer).

This then means that the amount of storage that is available to be allocated for storing new geometry items can be varied in use in a particularly efficient and seamless manner.

For instance, in embodiments, the access logic is operable to select between a first effective memory pool size in which a first address range within the memory pool is available to be allocated for storing new geometry items and a second effective memory pool size in which a second address range within the memory pool is available to be allocated for storing new geometry items, wherein the first address range is greater than the second address range. In this respect, the first and second address ranges are in embodiments both contiguous ranges with the second address range corresponding to a sub-range within the first address range. For example, in an embodiment, the access logic is operable to select between a first, “full” effective memory pool size in which the full address range within the memory pool is available to be allocated for storing new geometry items and a second, “restricted” effective memory pool size in which (only) a restricted address range within the memory pool is available to be allocated for storing new geometry items, but various arrangements would be possible in this regard.

Thus, when the effective memory pool size is to be increased from the second effective memory pool size to the first effective memory pool size, the access logic simply permits allocations for storing new geometry items to be performed within the full address range corresponding to the first effective memory pool size (i.e. the access logic extends the address range into which allocations for storing new geometry items can be performed).

Similarly, when the effective memory pool size is to be restricted from the first effective memory pool size to the second effective memory pool size, the access logic simply prevents allocations for storing new geometry items being performed outside of the restricted address range corresponding to the second effective memory pool size.

In this latter case, however, any allocations that have already been made outside of the restricted address range corresponding to the second effective memory pool size should still be used (and so this is in embodiments permitted, so that geometry items for which allocations have already been made outside the restricted range can still be stored/accessed), it is just that any new allocations of portions of the geometry buffer for storing geometry items should only be performed to addresses within the restricted range.

Thus, if portions of the memory pool outside of the restricted range have already been allocated for storing geometry items at the point at which the effective memory pool size is to be restricted, those allocations are in embodiments still used, and so the access logic in embodiments still permits access to portions of the memory pool outside of the restricted address range that have already been allocated for storing geometry items (e.g., so that geometry items can still be written to those allocations and read back (consumed) by further stages), but any subsequent allocations will only be performed within the restricted range, and so any new geometry items that are to be stored from that point will only be stored within the restricted range (unless the effective memory pool size is increased again).

Accordingly, any new allocations may need to wait until there is space available within the restricted range.

Thus, when it is desired for a larger amount of storage to be available to the geometry processing stage(s) in question, the access logic within the graphics processor that controls access to the geometry buffer may accordingly allow the geometry processing stage to use more of the memory pool, e.g. to use the full size of the memory pool, such that the full address range of the memory pool is accessible for storing new geometry items.

Correspondingly, when it is desired to reduce the amount of storage that is available to the geometry processing stage in question, the access logic may simply restrict the address range that is available for storing new geometry items.

In this way, the effective size of the memory pool can be changed in an essentially seamless manner, i.e. without requiring any draining or reconfiguring of the graphics processing pipeline, by the access logic associated with the sequence of geometry processing stages simply controlling the address range of the memory pool within which new geometry items can be stored.

In this respect, it will be appreciated that it would in principle also be possible to vary the actual, physical size of the memory pool(s) within the geometry buffer, i.e. by reconfiguring the set of memory pools, and this could therefore be done. In that case, however, changing the size of the memory pools may require draining the graphics processing pipeline of work, and so may reduce performance.

Thus, as mentioned above, it is in embodiments the maximum available, i.e. ‘effective’, size of the memory pool that is controlled (rather than the physical size of the memory pool which is in embodiments fixed at configuration time), and the technology described herein thus in embodiments allows the maximum amount of storage that is available to be allocated for storing geometry items to be varied in use without having to necessarily drain the pipeline.

Various arrangements would be possible in this regard.

For instance, in embodiments, as mentioned above, the access logic is operable to select between two possible effective memory pool sizes, e.g. a first, “full” size in which the full address range of the memory pool is available to be allocated for storing new geometry items, and a second, ‘restricted’ size in which only a restricted address range is available to be allocated for storing new geometry items, and this has been found to be effective for typical graphics processing applications.

However, in general, there may be any suitable and desired number of effective memory pool sizes that can be used, e.g. depending on the desired granularity of the control.

The present inventors thus recognise that it is beneficial to allow the graphics processor to be able to control the maximum amount of storage space that is available for storing new (temporary) geometry items produced by the sequence of geometry processing stages, and provides a mechanism to do this.

Further, according to embodiments at least, this can be (and is) done in a particularly efficient and seamless manner by controlling how much of a memory pool that has been allocated to the sequence of geometry processing stages is accessible for storing new (temporary) geometry items produced by the sequence of geometry processing stages, i.e. rather than having to reconfigure the actual size of the memory pool within the geometry buffer.

Thus, the control is performed by such access logic within the graphics processor, e.g., and in embodiments, without requiring any external (e.g. software) management.

The technology described herein also extends to the operation of the graphics processor itself in this way.

A further embodiment of the technology described herein thus comprises a graphics processor that is configured to execute a tile-based graphics processing pipeline in which a render output is generated by performing an initial, “geometry processing” pass and a subsequent, “rendering” pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective (render output) tiles,
wherein the graphics processor has access to a geometry buffer for storing (temporary) geometry items that are produced by the sequence of one or more geometry processing stages and then consumed during the initial, geometry processing pass, and
the graphics processor further comprising access logic for controlling access to the geometry buffer,
wherein the access logic is operable and configured to control a maximum amount of storage space within the geometry buffer that is available to be allocated for storing new geometry items produced by the sequence of one or more geometry processing stages.

Another embodiment of the technology described herein comprises a method of operating a graphics processor, wherein the graphics processor is configured to execute a tile-based graphics processing pipeline in which a render output is generated by performing an initial, “geometry processing” pass and a subsequent, “rendering” pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective (render output) tiles,
wherein the graphics processor has access to a geometry buffer for storing (temporary) geometry items that are produced by the sequence of one or more geometry processing stages and then consumed during the initial, geometry processing pass, and
the method comprising:
controlling a maximum amount of storage space within the geometry buffer that is available to be allocated for storing new geometry items produced by the sequence of one or more geometry processing stages, based on current processing conditions within the graphics processor.

As will be appreciated by those skilled in the art, these additional embodiments of the technology described herein relating to the operation of the graphics processor can, and in embodiments do, include any one or more or all of the features of the technology described herein described herein, as appropriate.

Thus, the graphics processor according to these additional embodiments may, and in embodiments does, correspond to the graphics processor described above and may be operated in the same manner.

Likewise, the geometry buffer that the graphics processor can access, as well as the control of the graphics processor's access to that geometry buffer, in embodiments corresponds to those according to the operations described above.

Thus, in embodiments, the maximum amount of storage space available for storing new (temporary) geometry items produced by the sequence of one or more geometry processing stages is controlled by effectively restricting (or not restricting) a size of a memory pool that has been allocated to the sequence of one or more geometry processing stages, in the manner described above.

As alluded to above, the control of the amount of storage space available for storing (temporary) geometry items according to the technology described herein can be (and generally is) performed based on system conditions, e.g., and in particular, based on the current processing conditions within the graphics processor.

For instance, the binning stage, when performing the desired binning processing to generate the data structures for identifying geometry to be processed when rendering respective tiles of a render output being generated, will need geometry items to have been suitably produced/processed by the geometry processing stages before the binning processing can be performed, such that the geometry processing stages effectively ‘feed’ the binning stage with geometry items for (binning) processing. The memory pool(s) within the geometry buffer thus effectively queue up geometry items for processing by the binning stage.

Therefore, in order to improve throughput/performance of the binning processing, it may be desirable to have relatively larger amounts of storage available for storing the (temporary) geometry items that are produced by the geometry processing stages. This should then increase the number of geometry items (packets) in-flight at a particular instant, thus reducing instances where the binning stage is waiting for geometry processing to complete.

For example, in an embodiment, as will be discussed further below, the binning processing is performed in a distributed manner, using a plurality of (binning) cores. In that case, as the number of cores that are available to perform the binning processing increases, the amount of storage available for storing the (temporary) geometry items produced by the geometry processing stages may accordingly also desirably be increased to ensure that there are sufficient numbers of geometry items in flight to feed the binning cores.

Thus, if the geometry/binning processing is performance critical, i.e. such that the geometry/binning processing is currently limiting the overall performance of the graphics processing system (in other words, the geometry/binning processing is “exposed”), it may be desirable to have a relatively larger amount of storage available for storing the (temporary) geometry items produced by the geometry processing stages.

The technology described herein facilitates this by allowing the size of the memory pool(s) allocated to the sequence of geometry processing stages to be effectively increased, at least temporarily, when it is appropriate to do so, i.e. by making a larger amount of (e.g. all of) the memory pool available to be allocated for storing new geometry items, as described above.

That is, if the geometry/binning processing is “exposed”, e.g., and in particular, such that the graphics processor is currently only performing geometry/binning processing (and other processing may be waiting for the geometry/binning processing to complete), it may be beneficial to complete the geometry/binning processing as quickly as possible, and it may therefore be appropriate for the sequence of geometry processing stages to have access to relatively larger (sized) memory pools.

In this case, there should also generally be less pressure on the cache system, such that the cache system should be able to efficiently handle a relatively larger geometry buffer, e.g., and in embodiments, without data from other processing causing the geometry buffer to spill out to memory.

Thus, when geometry/binning processing is “exposed”, the effective size of a memory pool within the geometry buffer can be, and in embodiments is, temporarily increased.

The present inventors also recognise, however, that in many graphics processing applications, the graphics processing workload is scheduled such that the geometry/binning processing for a given render pass is interleaved with the rendering/fragment processing for another (e.g. the previous) render pass. That is, most of the time, the geometry/binning processing is not “exposed”, as the graphics processor will also be performing other processing work.

In that case, whilst increasing the number of geometry items in flight may help improve the performance (i.e. speed) of the geometry/binning processing, this can in some situations lead to the overall graphics processing performance being reduced. For example, increasing the number of geometry items in flight may generally result in higher memory bandwidth, and hence increased energy consumption, which may mean that the graphics processor clock speed needs to be reduced. Having more geometry items in flight can also result in longer overall latency, such that the lifetime of the geometry items may be increased. Further, this can reduce caching performance.

For instance, in embodiments, as mentioned above, the geometry buffer resides within a cache, and this cache is in embodiments a shared cache, such that the other processing work that may be performed by the graphics processor may also access memory via the same cache. In that case, having greater numbers of geometry items in flight may thus result in data for the other processing work being evicted from the cache, which may lead to increased cache thrashing, and hence reduced performance (because of the higher number of cache misses) and further increases in memory bandwidth and energy consumption.

To give an example, the “full” size of the memory pool that is allocated to the sequence of geometry processing stages, and for which the particular control of the technology described herein is in embodiments applied, may correspond to approximately half the size of the (shared) L2 cache. If the “full” size of the memory pool were used, this may therefore have a significant impact on the rendering/fragment processing performance and bandwidth since the geometry/binning processing is likely to evict useful rendering/fragment processing data from the cache.

Further, in cases where the geometry/binning processing for a given render pass is interleaved with the rendering/fragment processing for another (e.g. the previous) render pass, the geometry/binning processing will not typically be performance limiting, as the rendering/fragment processing will typically take longer to finish, such that there is no particular benefit in trying to finish the geometry/binning processing as quickly as possible, as the corresponding rendering/fragment processing that will use the end result of the geometry/binning processing will not be able to start until the rendering/fragment processing for the previous render pass has finished.

Thus, in situations where the geometry/binning processing is not “exposed”, the inventors recognise that it may in fact be more beneficial to have relatively smaller amounts of storage available for storing geometry items produced by the geometry processing stages, to avoid the geometry/binning processing negatively impacting other rendering/fragment processing work that the graphics processor is performing contemporaneously in such a manner that the overall graphics processor performance is in fact reduced. Again, this is facilitated by the technology described herein, as the technology described herein allows the effective size of a memory pool within the geometry buffer to be restricted, when it is appropriate to do so, i.e. so that only a restricted portion of the memory pool is available to be allocated for storing (new) geometry items.

Thus, depending on whether the geometry/binning processing is “exposed” or not, it may be desirable to make more or less storage available for geometry items produced by the geometry processing stages, and the technology described herein facilitates this by allowing the effective size of a memory pool within the geometry buffer to be varied in use, based on the current graphics processing conditions.

For example, in embodiments, the effective size of the memory pool can be significantly reduced, such that the “restricted” size of the memory pool is less than 50% of the “full” size of the memory pool. In a preferred example the “restricted” size of the memory pool is 25% of the “full” size of the memory pool. So, for a 4 MB (shared) cache, the “full” size of the memory pool may be 2 MB and the “restricted” size of the memory pool may then be 512 KB. Other examples of suitable sizes would of course be possible.

In this regard, as mentioned above, it is expected that most of the time the geometry/binning processing will not be exposed, e.g. as the graphics processor will try to interleave the geometry/binning processing for one render pass with other processing work for another render pass, and so for many graphics processing applications the size of the memory pool will be effectively restricted for most of the time (as this may provide an overall improved graphics processor performance). Despite this, there are still situations where the geometry/binning processing is exposed. For example, this may be the case at the start of a sequence of render passes, and/or where there is a strict processing barrier between render passes. In such cases, the technology described herein allows the effective size of the memory pool to be increased (e.g. by making a larger portion of the memory pool available for storing new geometry items).

Thus, in embodiments, the access logic is configured to make a larger amount of storage space within the geometry buffer available to be allocated for storing new geometry items produced by the sequence of one or more geometry processing stages when it is determined based on current processing conditions within the graphics processor that the throughput of the binning stage should be increased, e.g. because the geometry/binning processing is currently limiting the performance of the graphics processor. In this respect, it will be appreciated that making the larger amount of storage space within the geometry buffer available may comprise increasing the amount of storage space (e.g. if it is currently restricted) or may comprise continuing to use the larger amount of storage space (i.e. if it is not currently restricted).

That is, the control should be, and in embodiments is, performed to increase the effective size of the memory pool only when it is beneficial to do so, e.g. where the geometry processing/binning is exposed.

There are various ways that the graphics processor can determine that the effective size of the memory pool should desirably be increased.

In general, this may be done based on determining that the throughput of the binning stage should desirably be increased, and that a larger amount of storage space should accordingly be made available to be allocated for storing (temporary) geometry items that are produced by the geometry processing stages.

For example, this may be determined based on the current utilisation of the rendering stage. Thus, if the rendering stage is currently not being utilised (or utilisation is low), this may indicate that the geometry/binning processing is currently exposed, and the rendering stage is waiting for the geometry/binning processing to complete, and so it may be desired to provide increase storage resource to the geometry/binning processing (and the access logic can therefore do so).

In this respect, it will be appreciated that the graphics processor will typically, and in embodiments does, comprise a scheduling unit (e.g. in the form of a job manager/command stream frontend) that provides a virtual machine (software) interface for the graphics processor for receiving processing work (e.g. from a host processor of the data processing system that the graphics processor is a part of) and that is operable to schedule processing work to the remainder of the graphics processor. This scheduling unit is thus able to determine the current processing workload, i.e. based on which (and which type of) processing jobs it is scheduling, and signal this accordingly to the access logic to perform the appropriate control.

For example, the scheduling unit (job manager/command stream frontend) typically issues rendering/fragment processing jobs to a fragment shader endpoint or iterator that breaks the jobs into smaller tasks that are then scheduled appropriately within the rendering stage (e.g. to different processing cores). The scheduling unit (job manager/command stream frontend) can thus determine whether the fragment shader endpoint or iterator is currently busy or not, and infer on this basis whether the geometry/binning processing is currently exposed.

Similarly, the scheduling unit (job manager/command stream frontend) is typically responsible for issuing geometry tasks to the sequence of geometry processing stages, and so can determine on that basis whether it may be desired to increase the throughput of the binning stage.

As another example, as mentioned above, if the scheduling unit (job manager/command stream frontend) encounters a strict processing barrier between render passes, it may be determined on this basis that the geometry/binning processing for the render pass after the barrier will be exposed. This is because the presence of the barrier means that the geometry/binning processing for the render pass after the barrier cannot be interleaved the rendering/fragment processing of the previous pass and so the geometry/binning processing immediately after the barrier will be exposed.

More generally, therefore, the determination that the maximum amount of storage space available for storing (temporary) geometry items should be increased (or, e.g., the determination that the throughput of the binning stage should be increased) may be, and in embodiments is, made based on the scheduling unit's knowledge of the current processing workload within the graphics processor.

The control of the amount of storage space that is available for storing (temporary) geometry items may however also take into account any other suitable system conditions, as desired.

For example, there may be other endpoints or iterators within the graphics processor, e.g. for compute or neural jobs, and the determination as to whether the throughput of the binning stage could or should be increased may also take into account the utilisation of these endpoints/iterators. Again, the scheduling unit (job manager/command stream frontend) can determine this.

Alternatively, or additionally, the particular control according to the technology described herein may be based more directly on performance monitoring within the graphics processor.

For instance, as discussed above, the inventors have recognised that in situations where the geometry/binning processing is not exposed, having a larger amount of storage resource accessible to the geometry/binning processing may lead to reduced cache performance. Thus, in embodiments, the cache performance may be monitored, and the access logic may be operable to restrict the amount of storage space that is available for storing (temporary) geometry items if the cache performance is reduced, e.g. in response to seeing increased bandwidth/energy, or increased cache thrashing. On the other hand, if it can be determined based on cache performance monitoring that the cache performance is not in fact reduced, restricting the amount of storage that is accessible may not be necessary, and so it may be beneficial to not do this.

As yet another example, the particular control according to the technology described herein may alternatively/additionally be performed based on monitoring suitable metrics, e.g. throughput, of the geometry processing/binning stages.

Thus, in various embodiments, the particular control according to the technology described herein may be performed based on any one or more of: determining that the geometry/binning processing is currently limiting the performance of the graphics processor (such that the geometry/binning processing should be completed as quickly as possible); determining that the graphics processor is busy with other non-geometry/binning processing (e.g. based on a current or expected utilisation of the rendering stage); identifying the presence of a strict processing barrier between successive render passes; and monitoring performance of the graphics processor, e.g., and particularly, monitoring cache performance.

Various other arrangements would be possible in this regard.

It will be appreciated from the above that the control is in embodiments therefore performed dynamically, e.g., such that the maximum amount of storage space that is available to be allocated for storing (temporary) geometry items (i.e. the effective size of the memory pool(s) within the geometry buffer) is varied in use (or over time) during operation of the graphics processor to perform a sequence of render passes.

In some embodiments, for example, the maximum amount of storage space that is available to be allocated for storing (temporary) geometry items may change within a single render pass.

For example, an increased amount of storage space may be made available at the start of the render pass, during a period in which the geometry/binning processing is exposed, but the amount of storage space may then be restricted, e.g. once the rendering/fragment processing stage is reached, at which point the geometry/binning processing for the next render pass may start but this geometry/binning processing should not be exposed as it will be interleaved with the rendering/fragment processing stage of the previous render pass.

As another example, however, rather than the graphics processor (scheduling unit) performing this control dynamically, i.e. based on its knowledge of the current processing workload within the graphics processor, the control could be performed by a (software) driver for the graphics processor, for example based on periodic profiling of the graphics processor. For example, the driver for the graphics processor could profile the amount of exposed geometry/binning processing in a previous one or more cycles, and determine based on this profiling whether the maximum amount of storage space that is available for storing (temporary) geometry items should be restricted (or not restricted) for the next cycle.

The technology described herein, in its embodiments at least, can therefore provide an effective mechanism for controlling the maximum amount of storage available to be allocated for storing (intermediate) geometry items in use, and hence improving the overall graphics processing performance by allowing the amount of available storage to be temporarily increased/restricted when it is appropriate to do SO.

The technology described herein may therefore provide various benefits compared to other possible approaches.

Subject to the particular requirements of the technology described herein, the graphics processor may otherwise be operable and configured in any suitable manner.

For instance, as mentioned above, the technology described herein relates to tile-based graphics processing in which a render output (e.g. a frame) is subdivided into plural rendering tiles for the purposes of rendering. In that case each rendering tile may and in embodiments does correspond to a respective sub-region of the overall render output (e.g. frame) that is being generated. For example, a rendering tile may correspond to a rectangular (e.g. square) sub-region of the overall render output. The graphics processor is thus in embodiments operable to execute and implement a tile-based graphics processing pipeline.

In particular, the tile-based graphics processing pipeline comprises (in order) a sequence of one or more geometry processing stages, a binning stage, and a rendering stage. When performing tile-based rendering, the geometry processing stages and the binning stage thus together perform the initial geometry processing/binning pass, whereas the rendering stage performs the subsequent deferred rendering pass. It will be appreciated that whilst these different stages are logically separate to one another, the various processing stages may share processing circuitry/circuits, etc., if desired.

The geometry processing that is and can be performed in the technology described herein can comprise any suitable and desired sequence of one or more geometry processing stages that may be performed as part of a graphics processing pipeline.

In an embodiment, the geometry processing comprises one or more of, and in embodiments plural of, the following geometry processing stages: a vertex shader (vertex shading); a tessellation control shader (tessellation control shading); a task shader (task shading); a tessellation shader (tessellation shading); a mesh shader (mesh shading); a tessellation evaluation shader (tessellation evaluation shading); a geometry shader (geometry shading); and a transform feedback shader (transform feedback shading). The geometry processing may comprise one or more of these shader stages, as desired.

The sequence of one or more geometry processing stages is in embodiments implemented and executed as a geometry processing pipeline, comprising the sequence of one or more geometry processing stages in question.

In embodiments, as mentioned above, the geometry processing (prior to the binning stage) operates to generate respective (geometry) “packets” that each store data for geometry to be processed (for the render output in question). Thus, the geometry “items” produced by the sequence of geometry processing stages may, e.g., and in embodiments do, comprise respective (geometry) packets. For example, in an embodiment a (and each) (geometry) packet that the geometry processing generates stores data for a set of one or more primitives (and in embodiments for a set of plural primitives) to be processed (for the render output in question).

Each (geometry) packet may store any suitable and desired data for the geometry (e.g. set of one or more primitives) that it relates to. For example, a (geometry) packet may, and in embodiments does, store appropriate attributes, such as positions and varyings, for a set of (in embodiments plural) vertices for the geometry (e.g. set of primitives) that the packet relates to, for example, and in embodiments, together with a set of identifiers (indices) for the vertices that can be used to determine how the vertices are used for the geometry (e.g. primitives) that the packet relates to. A packet in embodiments also contains connectivity information describing the primitives that the vertices within the packet are generating, A packet may also store attributes and identifiers for the geometry, e.g. primitives, itself, if desired, and/or other, e.g., state, information relating to the geometry that the packet relates to.

Other arrangements would, of course, be possible.

The initial (geometry) packets that are generated by the geometry processing may be created in any suitable and desired manner. For example geometry and/or work items (e.g. vertices) relating to that geometry may be progressively added to a packet, e.g. until a condition for finishing the packet (and, if necessary, starting a new packet), such as a maximum amount of geometry and/or work items for the packet being met, is reached.

In an embodiment, each respective geometry processing stage of the sequence of one or more geometry processing stages for the geometry processing (pipeline) that is being executed, generates a respective geometry packet, and provides that respective geometry packet as an input packet to a next geometry processing stage of the sequence (if any), with that next geometry processing stage of the sequence then processing the input packets that it receives to generate one or more output geometry packets, that are then provided as inputs to a next geometry processing stage of the sequence (if any), and so on.

Thus, in an embodiment, the first stage of the geometry processing, which in embodiments comprises position shading or vertex shading (comprising both position shading and varying shading, for example), acts as an “input packetizer” that generates initial packets storing data for geometry to be processed. These initial geometry packets are then in embodiments appropriately processed by (any) subsequent stages of the geometry processing to generate, for example, modified versions of the initial geometry packets and/or to generate additional geometry packets, as required. For example, a mesh shader may generate multiple packets from a single input (e.g. task shader) packet.

(It will be appreciated here that not all of the geometry processing for packets storing data for geometry to be processed for a render output needs to be performed in advance of and for the binning/tiling stage in a tile-based graphics processing pipeline, but rather some of that processing can, where appropriate, be deferred until the rendering/fragment processing stage of the graphics processing pipeline. Thus, in embodiments some of the geometry processing for packets may be effectively “deferred”, e.g., and in embodiments, until it has been determined that a packet storing data for geometry to be processed for a render output actually applies to a rendering tile.)

Various arrangements are possible in this respect.

Thus, the graphics processor in embodiments comprises a sequence of one or more geometry processing stages to perform geometry processing and to provide respective geometry items, e.g., and in embodiments, in the form of “packets” of geometry, to the binning stage for processing.

The binning stage will in embodiments then receive packets for processing from the geometry processing stages (which packets will have been subject to the appropriate and desired geometry processing within the geometry processing stages). The binning stage should then, and in embodiments does, process the packets it receives for processing to generate one or more data structures that can be used to determine whether (the respective) packets should be processed for respective rendering tiles.

Thus, the binning stage in embodiments generates one or more data structures that can be used to determine whether packets storing data for geometry to be processed should be processed for a rendering tile.

The “binning” data structures that are generated by the binning stage for this purpose can take any suitable and desired form. For example, they could comprise lists of packets to be processed for respective rendering tiles or sets of plural rendering tiles (which packet “tile” lists can then be used to determine which packets apply to a given tile). These “binning” data structures will typically be relatively larger, and will be used during the subsequent, rendering pass, and so these “binning” data structures may, e.g., be, and typically will be, written out by the binning stage to more permanent storage, e.g. to (main) memory (e.g. in contrast to the (temporary) geometry items that are in embodiments stored locally to the graphics processor in the geometry buffer as discussed above).

In an embodiment, the (binning) data structures that can be used to determine whether packets storing data for a set of one or more primitives to be processed should be processed for a rendering tile comprise, in embodiments hierarchies of, bounding boxes that can be used for that purpose. Most in embodiments this comprises both bounding boxes for respective individual packets, together with bounding boxes for respective groups of plural packets (and, if desired, for respective groups of groups of plural packets, and so on, if desired).

In this case to determine packets that should be processed for a rendering tile, the rendering tile can, and will be, compared against the respective bounding boxes to identify those packets that apply to the tile.

The binning stage can generate the data structures to be used to determine which packets should be processed for a rendering tile in any suitable and desired manner. In embodiments it uses an appropriate bounding box for a packet for this purpose. For example, in the case where the binning stage prepares lists of packets to be processed for tiles, a bounding box for a packet can be compared to the tiles'positions to identify which tile(s) the packet applies to. In the case where the binning data structure(s) comprises bounding boxes for packets, the bounding box for a packet can be included in those data structures appropriately.

The bounding box for a packet can be determined in any suitable and desired manner. For example, this could be determined based on performing position shading for vertices for primitives in the packet (where that information is available from the geometry processing that has been performed). Or, the bounding box could be derived using other information, e.g., and in embodiments, from the application for which the graphics processing being performed (application-supplied information), for example, and in embodiments, that defines a bounding volume for the packet and a way to transform the bounding volume to derive a bounding box for the packet. In this case therefore, there will be appropriate (meta)data associated with the packet, in embodiments provided by the application, e.g. that defines a bounding volume for the packet and the way to transform the bounding volume to determine a bounding box for the packet. The binning stage will then use this information to determine a bounding box for the packet in question.

In an embodiment, the binning stage can also or instead, in embodiments also, determine the bounding box for a packet from information that has been generated by a geometry processing stage or stage that has already been executed for the packet (and that precedes the geometry processing stage that is being deferred). This information can comprise any suitable and desired information that can allow a bounding box for a packet to be determined.

For example, in the case of a tessellation shader, the tessellation output may consist of barycentric coordinates (which will be expanded to vertices and primitives in a tessellation evaluation shader). In this case, the tessellation shader may be configured to provide the bounding volume in barycentric coordinates, with the tessellation evaluation shader being configured to transform those coordinates into screen space bounding box coordinates (which will then provide a bounding box for the packet in question).

Other arrangements would, of course, be possible.

The binning stage may also perform any other suitable processing on a geometry packet, as desired, such as appropriate culling operations for the primitives in the geometry packet, e.g., and in embodiments to (try to) cull primitives based on the view frustum and/or the facing direction of the primitives.

The binning stage may be implemented in any suitable and desired manner. For example, in embodiments, the binning stage is implemented by (or comprises) a set of plural processing (binning) cores, but other arrangements would of course be possible.

The end result of the geometry processing/binning stages is thus in embodiments to generate processed (primitive) packets which packets are then included into the appropriate data structure that can be used to determine whether packets should be processed for a rendering tile (and that is then processed by the rendering stage).

The sequence of one or more geometry processing stages and the binning stages are thus together configured to perform the initial geometry processing/binning processing pass of the tile-based rendering scheme.

Once the binning stage has generated the necessary data structure or structures to be used to determine when the packets storing data for geometry to be processed should be processed for a rendering tile for a render output (e.g. draw call) being processed, then the rendering (rendering stage) for the render output in question can be performed.

The rendering will be performed on a tile-by-tile basis (as the graphics processor is executing a tile-based graphics processing pipeline), and so accordingly, the rendering stage will, and in embodiments does, use the binning data structures generated by the binning stage to identify packets to be processed for respective rendering tiles. Thus, for a (and each) rendering tile to be processed for generating the rendering output, the binning data structure(s) generated by the binning stage will be, and are in embodiments, used to identify packets storing data for geometry to be processed for the rendering tile in question.

This can be done in any suitable and desired manner, and should, and in embodiments does, depend upon the nature of the binning data structures that the binning stage has generated. For example, where the binning stage generates lists of packets to be processed for respective rendering tiles or sets of rendering tiles, those lists can be used to identify the packets to be processed for a rendering tile. Where the binning stage generates (hierarchies of) bounding boxes for packets, a rendering tile may be compared to the bounding boxes to determine the packets that need to be processed for the rendering tile.

Correspondingly, the rendering stage in embodiments should, and in embodiments does, comprise an initial process of using the binning data structure(s) generated by the binning stage to identify packets to be processed for rendering tiles (which may comprise identifying packets to be processed for regions of the render output, as will be discussed further below).

The actual rendering process may be performed in any suitable and desired manner, e.g. using any suitable rendering scheme that a tile-based rendering system may normally use. For example, in embodiments the rendering is performed using rasterisation. However, it will be appreciated that the technology described herein is not necessarily limited to rasterisation-based rendering and may generally be used for other types of rendering, including ray tracing or hybrid ray tracing arrangements.

As discussed above, the graphics processor has access to a geometry buffer that is operable and configured to store (temporary) geometry items, e.g. packets of geometry, that are produced by the geometry processing stages and that will also be consumed during the initial, geometry processing pass. Geometry items within the geometry buffer that have been produced by one geometry processing stage may thus be accessed by further processing stages, including later geometry processing stages in the set of geometry processing stages and/or the binning stage, as required, to perform further processing.

However, once the initial, geometry processing pass for a particular render pass has finished, the geometry buffer for that render pass can thus be discarded, and storage space deallocated appropriately so that the geometry buffer can be used for the initial, geometry processing pass for a next render pass.

The particular (temporary) geometry items that are stored within the geometry buffer may be any suitable and desired geometry items (e.g. packets), depending on the configuration of the graphics processing pipeline that is being executed. For example, these could include substantially “complete” processed geometry items (packets) that are then provided to the binning stage for processing, or could be partially processed geometry items (packets) that will undergo further (geometry-related) processing with further stages of the graphics processing pipeline.

Subject to the particular requirements of the technology described herein, the geometry buffer may generally be configured in any suitable manner.

For example, in embodiments, as mentioned above, the geometry buffer resides in external storage, e.g. in main memory, and is configured as a set of one or more memory pools that can be allocated to the sequence of geometry processing stages, as desired.

In this respect, it will be appreciated that multiple geometry processing stages may have access to a particular memory pool within the geometry buffer. For instance, a given geometry processing stage may be able to allocate space within a memory pool for storing new geometry items, and other geometry processing stages may then be able to access those geometry items from within the memory pool. Another geometry processing stage may then be able to trigger ‘deallocation’ in respect of geometry items, i.e. to free up space within the memory pool for storing new geometry items, once a previously produced geometry item has been used.

In embodiments, as discussed above, the graphics processor comprises a cache that is operable to transfer data between the graphics processor and a memory system (e.g. main memory). The geometry buffer in embodiments resides within this cache, and so is backed by the memory system. However, the geometry buffer is in embodiments configured and controlled such that the geometry buffer resides fully within the cache, and is in embodiments therefore not written out to memory.

As mentioned above, the cache is in embodiments a shared cache that will also be used by other processing/processing units within the graphics processor. For example, data for the rendering/fragment processing operations may also be transferred via the same cache in which the geometry buffer resides. The geometry buffer is in embodiments therefore logically separate to any other buffers that may reside in the shared cache, and is in embodiments backed by a different portion of the memory system. Similarly, the geometry buffer is in embodiments separate to the storage that is used for the so-called “intermediate” geometry data that is produced as the end result of the initial, geometry processing pass.

The above describes the main elements and operation of the graphics processor and graphics processing pipeline that are relevant to operation in the manner of the technology described herein.

As will be appreciated by those skilled in the art, the graphics processor can otherwise include and execute, and in embodiments does include and execute, any one or one or more, and in embodiments all, of the processing stages and circuits that graphics processors and graphics processing pipelines may (normally) include.

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus it may comprise, for example, a tile to be generated in a tile based graphics processing system, and/or a frame of output fragment data. The technology described herein can be used for all forms of output that a graphics processor and processing pipeline may be used to generate, such as frames for display, render-to-texture outputs, etc. In an embodiment, the output is an output frame, and in embodiments an image.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, and stages of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor.

Equally, as mentioned above, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuitry of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

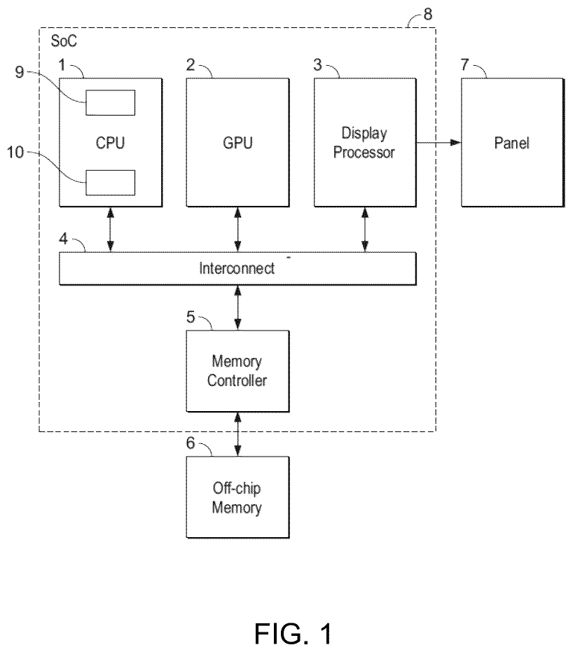

FIG. 1 shows an exemplary system on chip (SoC) graphics processing system 8 that comprises a host processor comprising a central processing unit (CPU) 1, a graphics processor (GPU) 2, a display processor 3, and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

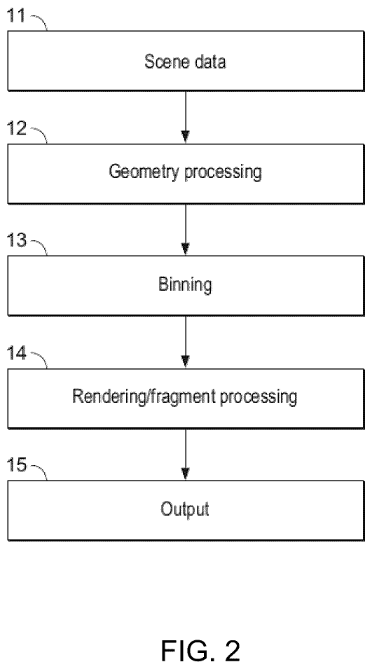

FIG. 2 shows schematically the processing sequence of the graphics processing pipeline executed by the graphics processor 2 when generating an output in the present embodiments.

FIG. 2 shows the main elements and pipeline stages. As will be appreciated by those skilled in the art there may be other elements of the graphics processor and processing pipeline that are not illustrated in FIG. 2. It should also be noted here that FIG. 2 is only schematic, and that, for example, in practice the shown pipeline stages may share significant hardware circuits, even though they are shown schematically as separate stages in FIG. 2. It will also be appreciated that each of the stages, elements and units, etc., of the processing pipeline as shown in FIG. 2 may, unless otherwise indicated, be implemented as desired and will accordingly comprise, e.g., appropriate circuitry, circuits and/or processing logic, etc., for performing the necessary operation and functions.

As shown in FIG. 2, for an output to be generated, a set of, e.g. scene data 11, including, for example, and inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in embodiments, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

There is then a geometry processing stage or stages 12, which performs appropriate geometry processing of and for the scene data to generate the data that will then be required for rendering the output. This geometry processing 12 can comprise any suitable and desired geometry processing that may be performed as part of a graphics processing pipeline.

In the present embodiments, this geometry processing comprises at least performing vertex processing (vertex shading) of attributes for vertices to be used for primitives for the render output being generated. In particular, appropriate vertex position shading is performed to transform the positions for the vertices from the, e.g. “model” space in which they are initially defined, to the, e.g., “screen”, space that the output is being generated in. In embodiments, the vertex shading also comprises generating and/or processing other, non-position attributes of vertices (varyings/varying shading). It would also be possible for some or all the varying shading to be deferred from the geometry processing and, for example, to be triggered at the binning or rendering stages instead, if desired.

As well as appropriate vertex shading, the geometry processing may comprise any other form of geometry processing that is desired, such as one or more of tessellation shading, transform feedback shading, mesh shading, or task shading. This geometry shading may also generate and/or process attributes for vertices, and/or it may process and generate attributes for primitives as well.

Once the desired geometry processing has been performed, there is then, in the present embodiments, as shown in FIG. 2, a binning/tiling stage 13. (It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.)

The binning process operates to generate appropriate data structures for determining which primitives need to be processed for respective rendering tiles of the output being generated. For example, it may sort the primitives into appropriate primitive lists, which indicate the primitives to be processed for respective tiles or sets of tiles. Alternatively, it may generate other data structures, such as hierarchies of bounding boxes, that can then be used at the rendering/fragment processing stage to identify those primitives that need to be processed for a respective tile.

The binning/tiling process 13 may also cull primitives that are not visible (e.g. that fall outside the view frustum, and/or based on the facing direction of the primitives).

As part of the geometry processing and/or the binning/tiling operation the primitives to be processed will be “assembled”. The primitives will, as discussed above, be assembled from a set of indices referencing vertices in a set of vertices for the render output processing being performed, based on primitive configuration information indicating how the vertex indices are to be assembled into primitives for processing when generating the render output.

Such primitive assembly may be performed as part of and at an appropriate stage of the geometry processing and/or as part of the binning/tiling processing, as desired. There may also, if desired, be two (or more) “primitive assembly” operations. For example, an initial primitive assembly operation could be performed to identify those vertices that will actually be used for the render output being generated before performing any vertex shading of the vertices, but with there then being a later primitive assembly stage that provides a sequence of assembled primitives for the binning/tiling stage.

Once the binning/tiling process has generated the necessary data structures for identifying the primitives to be processed for respective tiles of the render output, the primitives can then be and are then subjected to appropriate rendering/fragment processing 14. This operation is performed in the present embodiments on a tile-by-tile basis, using the data structures generated by the tiling/binning process 13 to identify those primitives that need to be processed for a respective tile.

The rendering/fragment processing can comprise any suitable and desired rendering and fragment processing operations that may be performed. Thus it may comprise, for example, first rasterising primitives to be processed for a tile to fragments, and then processing those fragments accordingly (e.g., and in embodiments, by performing appropriate fragment shading of the fragments). The rendering/fragment processing may also or instead comprise performing ray tracing operations, such as performing the rendering by tracing rays for respective fragments representing respective sets of one or more sampling positions of the output being generated. Hybrid ray tracing operations would also be possible, if desired.

The output of the rendering/fragment processing (the rendered fragments) is written to a tile buffer (not shown). Once the processing for the tile in question has been completed, then the tile will be written to an output data array in memory 6, and the next tile processed, and so on, until the complete output data array 15 has been generated. The process will then move on to the next output data array (e.g. frame), and so on.

The output data array may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.

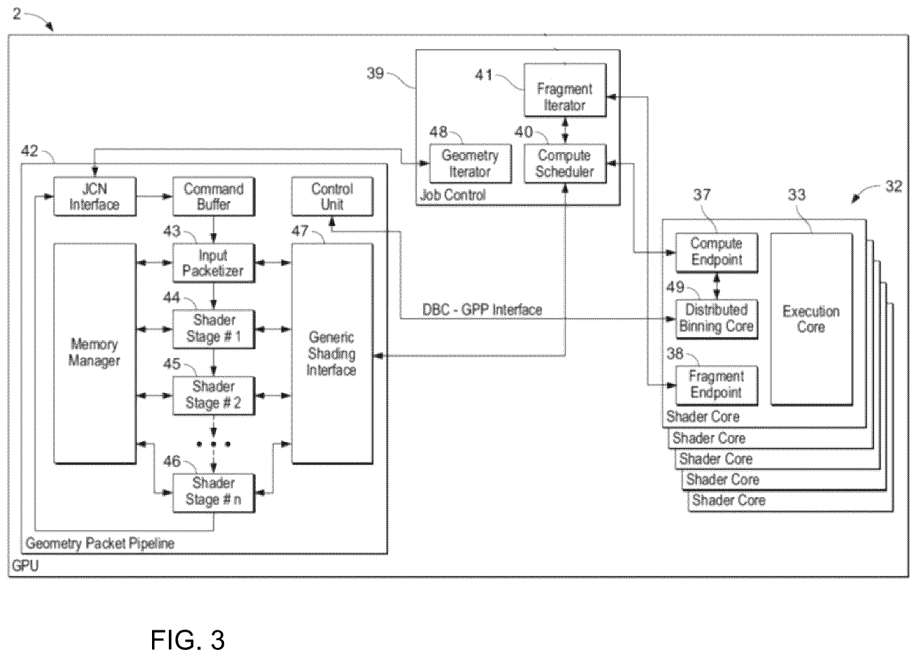

FIG. 3 shows an embodiment of a graphics processor (GPU) 2 that can execute a graphics processing pipeline of the form shown in FIG. 2, and that can be operated in the manner of the technology described herein.

As shown in FIG. 3, the graphics processor 2 comprises a plurality of processing (shader) cores 32 which are each operable to execute (shader) programs to perform processing operations. As shown in FIG. 3 each shader core 32 to facilitate this comprises a programmable execution unit (execution core) 33 that is operable to execute program instructions to perform processing operations.

In the present embodiments, the shader cores 32 are operable to execute both “compute” shader programs (to perform so-called compute shading) and fragment shader operations. Thus as shown in FIG. 3, each shader core 32 comprises an appropriate compute endpoint 37 and fragment endpoint 38 that act as the control interface for performing compute shading and fragment processing, respectively, and that will, for example, and in embodiments, trigger the execution core 33 to execute the appropriate compute shading or fragment shading tasks, as required.

As shown in FIG. 3, the compute endpoint 37 and fragment endpoint 38 receive appropriate processing tasks from a job control unit 39 of the graphics processor 2, which job control unit 39 includes an appropriate compute scheduler 40 and fragment iterator 41 for distributing processing jobs that the job controller 39 receives as appropriate processing jobs to the shader cores 32.

As discussed above, when performing graphics processing, there will typically be an initial geometry processing stage that determines the vertex and other data that is necessary for generating the graphics processing output in question, which will then be followed by a rendering/fragment processing stage for processing (rendering) that geometry.

In the present embodiments, the geometry processing is performed, as shown in FIG. 3, by a geometry packet pipeline 42 of the graphics processor 2. This geometry packet pipeline is operable to trigger the performance of one or more “geometry” shader stages (which shader stages themselves will be executed by the shader cores 32, under the control of the geometry packet pipeline 42).

For example, as shown in FIG. 3, the geometry packet pipeline 42 comprises an input packetizer 43 that can trigger position shading and vertex shading by the shader cores 32. It also includes further shader stage circuits 44, 45, 46 that are operable to trigger compute shaders for performing geometry processing, such as task shaders, mesh shaders, tessellation shaders, etc. (which again will be executed by the shader cores 32).

As shown in FIG. 3, the geometry packet pipeline 42 has an appropriate interface 47 to the compute scheduler 40 of the job control unit 39, via which it can control and trigger the performance of appropriate geometry shading operations by the shader cores 32.

The overall operation of the geometry packet pipeline 42 is controlled by the job control unit 39 (by a geometry iterator 48 of the job control unit 39) which distributes the appropriate geometry processing jobs and tasks to the geometry packet pipeline 42.

The graphics processor 2 of FIG. 3 is configured to perform rendering in a tile-based manner (as discussed above). To facilitate this, as shown in FIG. 3, each shader core 32 also includes a distributed binning core 49 that is operable to generate appropriate data structures for determining which primitives need to be processed for respective rendering tiles of the output being generated.

In the present embodiments, the distributed binning cores 49 generate hierarchies of bounding boxes for primitives and primitive packets (that contain primitives to be rendered) (which are then used at the rendering/fragment processing stage to identify those primitives that need to be processed for a respective tile).

The distributed binning cores 49 may also cull primitives that are not visible (e.g. that fall outside the view frustum, and/or based on the facing direction of the primitives).

The distributed binning cores 49 can operate in any suitable and desired manner for this purpose.

The distributed binning cores 49 of the shader cores 32 may trigger vertex shading, such as varying shading, as part of their operation (e.g. where varying shading was not performed by the input packetizer as part of the input packetizer 43 operation).

In the present embodiments, the rendering/fragment processing is performed by executing appropriate fragment processing operations on a shader core 32 under the control of the fragment endpoint 38. To facilitate this, the fragment endpoint 38 of each shader core is operable to trigger appropriate fragment shader operation by a shader core.

As will be appreciated from the above, in operation of the present embodiments, the geometry packet pipeline 42 that performs the geometry processing will generate appropriate geometry data, such as (transformed) vertex positions, vertex varyings, and primitive attributes, which data will then be used, for example, by the binning/tiling processing and rendering/fragment processing of the later stages of the graphics processing pipeline.

In the present embodiments, the geometry packet pipeline 42 operates to generate respective geometry packets containing the data that it generates. In the present embodiments, those geometry packets are then processed by the distributed binning cores 49 to generate corresponding primitive packets, which primitive packets are then used by the fragment processing (fragment shaders) 52.

Thus, in the present embodiments, the geometry packet pipeline 42 will generate geometry packets that store attributes for vertices and primitives, which geometry packets will then be read and used by the distributed binning cores 49.

Correspondingly, the distributed binning cores 49 will generate appropriate primitive packets storing attributes for vertices and primitives, which primitive packets will then be read and used by the fragment processing 38.

Other arrangements would of course be possible. For example, rather than the geometry packet pipeline 42 generating geometry packets that are then read and used by the distributed binning cores 49 as shown in FIG. 3, the geometry packet pipeline 42 could interface and provide geometry packets to a (dedicated) tiling unit that then performs more traditional tiling operations, e.g. in the normal (serialized) manner for tile-based graphics processing, using the geometry packets.

To facilitate the operations described above, the geometry packet pipeline 42 will be associated with suitable storage for holding the temporary geometry (e.g. vertex) data that is produced by the geometry packet pipeline 42 but that will also be consumed either by the geometry packet pipeline 42 or by the distributed binning cores 49 as part of the initial pass (i.e. before the rendering/fragment processing 14).

In the present embodiments, this storage is configured as a memory pool and this memory pool is divided into packets within the geometry packet pipeline 42. The geometry packet pipeline 42 thus includes a memory manager 50 that contains access logic for controlling access to this memory pool.

The geometry packet pipeline 42 thus includes a memory manager 50 that contains access logic for controlling access to this memory pool.

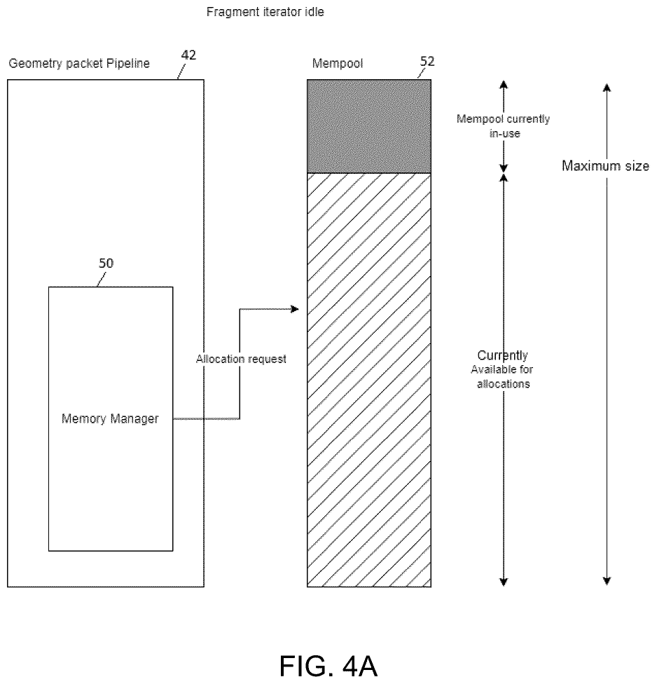

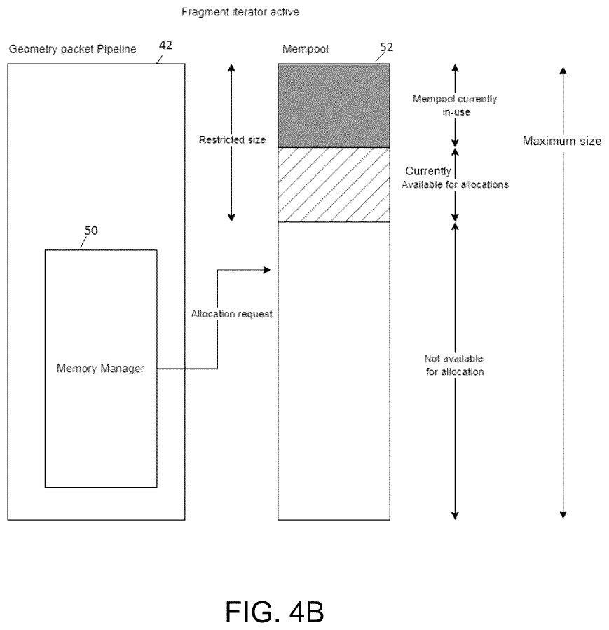

As shown in FIG. 4A, the memory pool 52 may have a certain total size corresponding to the physical size of the memory pool 52. The total/physical size of the memory pool 52 may be configured for example such that the memory pool 52 can reside entirely within a level 2(L 2 ) cache of the graphics processor 2.

FIG. 4A shows that a portion of the memory pool 52 is currently in-use, i.e. it has been allocated for storing one or more packets produced by the geometry packet pipeline 42. The remainder of the memory pool 52 is thus available to be allocated for storing new packets produced by the geometry packet pipeline 42.

Thus, when the geometry packet pipeline 42 issues a packet allocation request to trigger allocating a portion of the memory pool 52 for storing data for a new packet, this packet allocation request is handled by the memory manager 50, which will attempt to allocate a portion of the memory pool 52 for that packet within the portion of the memory pool 52 that is currently available by issuing an appropriate allocation request.

The memory pool 52 will thus be filled up in this way. At some point, the geometry packet pipeline 42 may have finished processing a packet, and a suitable packet deallocation request may be triggered to free up that portion of the memory pool 52. Again, this is handled by the memory manager 50 issuing an appropriate deallocation request to deallocate the portion of the memory pool 52 storing the packet in question (that is to be deallocated).

It will be appreciated, therefore, that the amount of storage stage that is actually available to be allocated for storing new packets, in use, will depend on how much of the memory pool 52 is currently in-use. Thus, if the memory pool 52 becomes full the memory manager 50 may then need to stall new allocation requests until space becomes available, i.e. due to one or more packets being deallocated. In the example shown in FIG. 4A, however, the maximum amount of storage space that is available to be allocated for storing new packets is determined by the total/physical size of the memory pool 52 and corresponds to the full size of the memory pool 52.

In the present embodiments, rather than the full size of the memory pool 52 always being available to be allocated for storing packets, e.g. as shown in FIG. 4A, the access logic within the memory manager 50 is operable to selectively restrict the effective size of the memory pool 52 by restricting the maximum amount of storage space within the memory pool 52 that is available to be allocated for storing new geometry packets, when it is appropriate to do so.

Thus, according to the present embodiments, the size of the memory pool 52 can be effectively restricted, as shown in FIG. 4B, so that the maximum amount of storage space that is available for storing new geometry packets (and to which new memory allocation requests can be issued) is restricted.

This may be done, for instance, based on current processing conditions within the graphics processor. For instance, the inventors recognise that depending on whether the geometry processing is currently “exposed”, it may be desirable to have a larger or smaller memory pool 52 available. In particular, when the geometry processing is exposed, the inventors recognise it may be beneficial for the geometry processing/binning to finish as quickly as possible. Therefore, using the full, extended size of the memory pool 52, as shown in FIG. 4A, may be appropriate in this case, since this then allows the geometry processing/binning throughput to be increased.

On the other hand, as discussed earlier, in most graphics processing applications, the geometry processing/binning will typically not be exposed, e.g. because the geometry processing/binning for a given render pass will often be interleaved with fragment processing from another, previous render pass (unless there is a barrier that means this is not the case). In that case, the inventors recognise that it may be appropriate/beneficial to use the restricted size of the memory pool 52, as shown in FIG. 4B, as this can reduce caching issues.

In the present embodiments, the determination as to whether or not the geometry processing is “exposed”, and whether or not the size of the memory pool 52 should be restricted is based on monitoring whether the fragment iterator 41 is actively issuing fragment processing work to the processing (shader) cores 32.

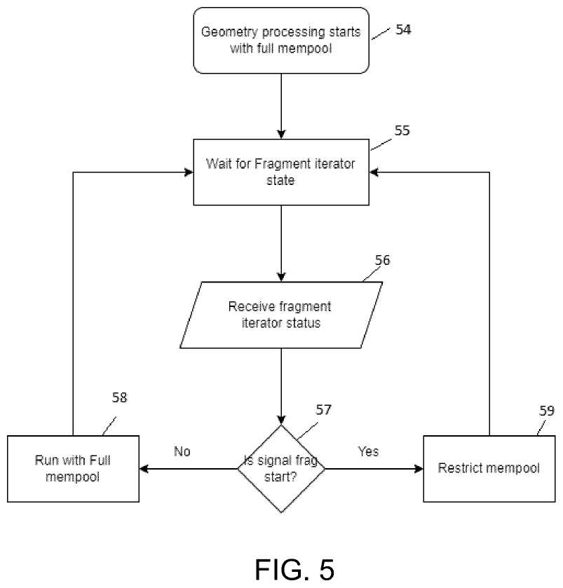

FIG. 5 is thus a flow chart illustrating a memory management operation according to an embodiment in which a sequence of render passes is to be performed. In this example, the geometry processing for the first render pass in the sequence of render pass starts (step 54). At this point it is known that the geometry processing will be exposed (since this is the first render pass in the sequence of render passes being performed) and so the full size of the memory pool 52 is used.

The fragment iterator 41 state is then monitored (step 55). When an update to the fragment iterator 41 state is received (step 56), this is then signalled accordingly to the access logic within the memory manager 50, and it is determined from this update whether or not the fragment iterator 41 is currently active. If the update indicates that the fragment iterator 41 is active (i.e. it has started to issue fragment processing work to the processing (shader) cores 32) (step 57-yes), the size of the memory pool 52 is accordingly restricted (step 59), and the processing continues with the restricted size of the memory pool 52.

The fragment iterator 41 state is then still monitored (step 55) and at some point, if an update to the fragment iterator 41 state is received that indicates that the fragment iterator 41 is not active (step 57-no), it is determined on this basis that the geometry processing is exposed, and so the size of the memory pool 52 is accordingly extended (step 58), so that the processing is performed with the full size of the memory pool 52, e.g. until another update is received.

In this way, the effective size of the memory pool 52 can be dynamically controlled by restricting (or not restricting) the maximum amount of storage space within the memory pool 52, and this can be done based on current processing conditions within the graphics processor to try to improve the overall graphics processing performance.

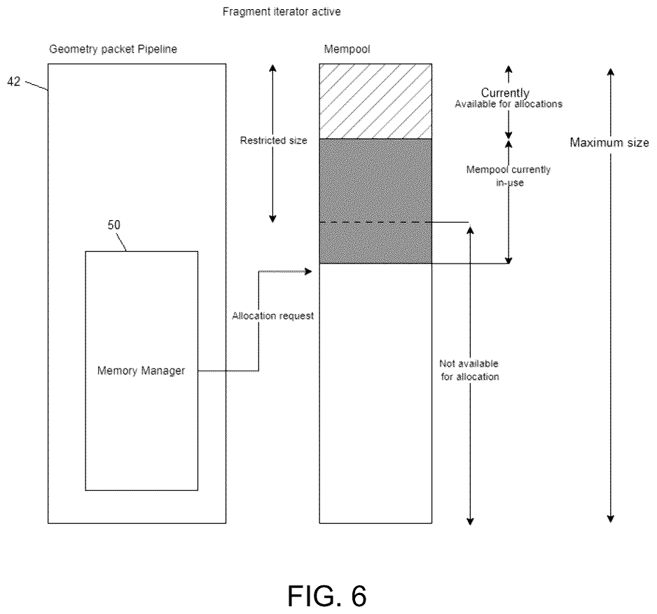

It will be appreciated that at the point at which the size of the memory pool 52 is to be restricted (i.e. in step 59 of FIG. 5), there may be portions of the memory pool 52 outside the restricted size portion of the memory pool 52 that have already been allocated for storing geometry packets, before the restriction was put in place. FIG. 6 illustrates this situation. In this case, the access logic within the memory manager 50 is permitted to only perform new allocations within the restricted size portion of the memory pool 52 (as in FIG. 4B, above). However, the portion of the memory pool 52 that is currently in-use and that is outside of the restricted size portion of the memory pool 52 remains accessible/usable until it is deallocated.

This then allows a more seamless transition as any allocations that have been performed prior to restricting the size of the memory pool 52 are still valid, and can be used accordingly. Any new allocation requests will however only be performed within the restricted size portion of the memory pool 52. Thus, once the in-use portion of the memory pool 52 that is outside of the restricted size portion of the memory pool 52 has been deallocated, it is not then available to be allocated for storing new geometry items (i.e. unless/until the size of the memory pool 52 is subsequently extended, i.e. in step 58 of FIG. 5).

Various other arrangements would be possible.

For instance, although for ease of explanation the present embodiments are described with reference to a single memory pool, in general the storage may be configured as a set of memory pools that are accessible by the different stages within the geometry packet pipeline 42 and the particular control described above may in that case be applied to any one or more of those memory pools.

It will be appreciated that the technology described herein, at least in embodiments, allows for improved graphics processing performance when executing a tile-based graphics processing pipeline in which a render output is generated by performing an initial, geometry processing pass and a subsequent, rendering pass, in particular by allowing the effective size of a memory pool that is used to store temporary geometry data that is both produced and consumed by the initial, geometry processing pass to be dynamically varied in use, in particular so that the size of the memory pool can be temporarily increased when it is beneficial to do so, but without requiring the full size of the memory pool to always be available as this may detriment, e.g., caching performance in typical graphics processing conditions.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein described herein, in various embodiments and with various modifications as are suited to the particular use contemplated. It is intended that the scope be defined by the claims appended hereto.

1. A graphics processor that is configured to execute a tile-based graphics processing pipeline in which a render output is generated by performing an initial, geometry processing pass and a subsequent, rendering pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective tiles,
wherein the graphics processor has access to a geometry buffer for storing geometry items that are produced by the sequence of one or more geometry processing stages and then consumed during the initial, geometry processing pass, and
the graphics processor further comprising access logic for controlling access to the geometry buffer,
wherein the access logic is operable and configured to control a maximum amount of storage space within the geometry buffer that is available to be allocated for storing new geometry items produced by the sequence of one or more geometry processing stages.

2. The graphics processor of claim 1, wherein the geometry buffer is configured as a set of one or more memory pools that can be allocated to the sequence of one or more geometry processing stages, and
wherein the access logic is operable and configured to control the maximum amount of storage space within the geometry buffer that is available to be allocated for storing new geometry items produced by the sequence of one or more geometry processing stages by:
controlling how much of a memory pool within the geometry buffer that has been allocated to the sequence of one or more geometry processing stages is available to be allocated for storing new geometry items.

3. The graphics processor of claim 2, wherein each memory pool has a certain allotted size within the geometry buffer corresponding to a full address range for the memory pool, and
wherein controlling how much of the memory pool is accessible for storing new geometry items comprises selectively restricting the address range that is available to be allocated for storing new geometry items produced by the sequence of one or more geometry processing stages, to thereby control an effective size of the memory pool.

4. The graphics processor of claim 3, wherein the access logic is operable to select between a first effective memory pool size in which the full address range within the memory pool is available to be allocated for storing new geometry items and a second effective memory pool size in which only a restricted address range within the memory pool is available to be allocated for storing new geometry items.

5. The graphics processor of claim 4, wherein when the effective memory pool size is to be increased from the second effective memory pool size to the first effective memory pool size, the access logic permits allocations for storing new geometry items to be performed within the full address range corresponding to the first effective memory pool size.

6. The graphics processor of claim 4, wherein when the effective memory pool size is to be restricted from the first effective memory pool size to the second effective memory pool size, the access logic prevents allocations for storing new geometry items being performed outside of the restricted address range corresponding to the second effective memory pool size, but still permits access to portions of the memory pool outside of the restricted address range that have already been allocated for storing geometry items.

7. The graphics processor of claim 1, wherein the access logic is configured to increase the maximum amount of storage space within the geometry buffer available to be allocated for storing new geometry items produced by the sequence of one or more geometry processing stages when it is determined based on current processing conditions within the graphics processor that the throughput of the binning stage should be increased.

8. The graphics processor of claim 7, wherein the determination that the throughput of the binning stage should be increased is based on current utilisation of the rendering stage.

9. The graphics processor of claim 1, wherein the graphics processor comprises a cache that is operable to transfer geometry items produced by the sequence of one or more geometry processing stages between the graphics processor and the geometry buffer, and wherein the geometry buffer is configured and sized to fit within the cache.

10. The graphics processor of claim 1, comprising a set of plural processing cores, wherein the binning stage is distributed between the set of plural processing cores.

11. A method of operating a graphics processor, wherein the graphics processor is configured to execute a tile-based graphics processing pipeline in which a render output is generated by performing an initial, geometry processing pass and a subsequent, rendering pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective render output tiles,
wherein the graphics processor has access to a geometry buffer for storing geometry items that are produced by the sequence of one or more geometry processing stages and then consumed during the initial, geometry processing pass,
the method comprising:
controlling a maximum amount of storage space within the geometry buffer that is available to be allocated for storing new geometry items produced by the sequence of one or more geometry processing stages, based on current processing conditions within the graphics processor.

12. The method of claim 11, wherein the geometry buffer is configured as a set of one or more memory pools that can be allocated to the sequence of one or more geometry processing stages, and
wherein the access logic is operable and configured to control the maximum amount of storage space within the geometry buffer that is available to be allocated for storing new geometry items produced by the sequence of one or more geometry processing stages by:
controlling how much of a memory pool within the geometry buffer that has been allocated to the sequence of one or more geometry processing stages is available to be allocated for storing new geometry items.

13. The method of claim 12, wherein each memory pool has a certain allotted size within the geometry buffer corresponding to a full address range for the memory pool, and
wherein controlling how much of the memory pool is accessible for storing new geometry items comprises selectively restricting the address range that is available to be allocated for storing new geometry items produced by the sequence of one or more geometry processing stages, to thereby control an effective size of the memory pool.

14. The method of claim 13, comprising selecting between a first effective memory pool size in which the full address range within the memory pool is available to be allocated for storing new geometry items and a second effective memory pool size in which only a restricted address range within the memory pool is available to be allocated for storing new geometry items.

15. The method of claim 14, wherein when the effective memory pool size is to be increased from the second effective memory pool size to the first effective memory pool size, the method comprises permitting allocations for storing new geometry items to be performed within the full address range corresponding to the first effective memory pool size.

16. The method of claim 14, wherein when the effective memory pool size is to be restricted from the first effective memory pool size to the second effective memory pool size, the method comprises preventing allocations for storing new geometry items being performed outside of the restricted address range corresponding to the second effective memory pool size, but still permitting access to portions of the memory pool outside of the restricted address range that have already been allocated for storing geometry items.

17. The method of claim 11, comprising increasing the maximum amount of storage space within the geometry buffer available to be allocated for storing new geometry items produced by the sequence of one or more geometry processing stages when it is determined based on current processing conditions within the graphics processor that the throughput of the binning stage should be increased.

18. The method of claim 17, wherein the determination that the throughput of the binning stage should be increased is based on current utilisation of the rendering stage.

19. The method of claim 11, wherein the graphics processor comprises a cache that is operable to transfer geometry items produced by the sequence of one or more geometry processing stages between the graphics processor and the geometry buffer, and wherein the method comprises holding the geometry buffer within the cache.

20. A non-transitory computer readable medium storing instructions that when executed by one or more processor will cause the one or more processor to perform a method of operating a graphics processor, wherein the graphics processor is configured to execute a tile-based graphics processing pipeline in which a render output is generated by performing an initial, geometry processing pass and a subsequent, rendering pass,
wherein the initial, geometry processing pass of the graphics processing pipeline being executed by the graphics processor comprises:
a sequence of one or more geometry processing stages to perform geometry processing; and
a binning stage to generate data structures for identifying geometry to be processed when rendering respective tiles of a render output being generated, and
wherein the subsequent, rendering pass of the graphics processing pipeline being executed by the graphics processor comprises a rendering stage that renders respective render output tiles,
wherein the graphics processor has access to a geometry buffer for storing geometry items that are produced by the sequence of one or more geometry processing stages and then consumed during the initial, geometry processing pass,
the method comprising:
controlling a maximum amount of storage space within the geometry buffer that is available to be allocated for storing new geometry items produced by the sequence of one or more geometry processing stages, based on current processing conditions within the graphics processor.
